(19) United States
(12) Patent Application Publication
(10) Pub. No.: US 2009/0211102 A1
(43) Pub. Date: Aug. 27, 2009

(54) Foldable Knife

(76) Inventor: Chia-Ying Chen, Sanchong City (TW)

Correspondence Address: BACON & THOMAS, PLLC, 625 SLATERS LANE, FOURTH FLOOR, ALEXANDRIA, VA, 22314-1176, US

(21) Appl. No.: 12/078,590

(22) Filed: Apr. 2, 2008

(30) Foreign Application Priority Data
Feb. 22, 2008 (TW) 097203074

(51) Int. Cl. B26B 1/04

(52) U.S. Cl. 30/161

(57) ABSTRACT

A foldable knife comprises a blade pivotally connected to a pivotal portion at a first end of a handle. A resilient bar extends between a second end of the handle and the pivotal portion. When the blade is received in the handle, the resilient bar biases the blade with a torque to rotate the blade into the handle. When the blade is rotated outward from the handle up to a predetermined angle, the resilient bar biases the blade with a torque to rotate the blade out of the handle. A switch element has a first end extended out of the handle for being switched. When the switch element is switched, a second end thereof biases the blade and rotates it out of the handle. The user can use only one hand to hold the foldable knife and switch the switch element to make the blade spring out of the handle.

### FIELD OF THE INVENTION

The present invention relates to a foldable knife, and more particularly to a foldable knife which can be operated by one hand.

### BACKGROUND OF THE INVENTION

Presently, a traditional foldable knife generally comprises a handle and a blade, wherein the blade has an end pivotally connected to an end of the handle. Thus, the blade can be rotated in relation to a pivotal portion thereof, so that the blade is rotated into the handle and received therein, or rotated out of the handle for use. When a user wants to use the traditional foldable knife, the user must hold the handle with one hand, and draw the blade with the other hand, so as to rotate the blade out of the handle. Therefore, a disadvantage of the traditional foldable knife is that the user cannot rotate the blade out of the handle with only one hand, which is very inconvenient. Furthermore, when the user draws the blade to rotate it out of the handle, a tip of the blade may accidentally cut the hand of the user, which is extremely dangerous.

To effectively solve the foregoing problems of the traditional foldable knife, related manufacturers have developed another foldable knife as shown in FIG. 1. The foldable knife designated by numeral 1 comprises a handle 10, a blade 11, a push button 12, a compression spring 13, and a torsion spring 14. The blade 11 is formed with a pivotal hole 110, and is pivotally connected to the handle 10 via the pivotal hole 110, so that the blade 11 can be rotated in relation to a pivotal portion thereof. The torsion spring 14 is provided where the blade 11 is pivotally connected to the handle 10, and biases the blade 11 with a torque to rotate the blade 11 out of the handle 10. The compression spring 13 has a first end connected to the handle 10 and a second end connected to the push button 12. The push button 12 protrudes out of a surface of the handle 10, so as to be pressed by a user. Meanwhile, the push button 12 can engage with the blade 11, so as to retain the blade 11 in a received state. Thus, the user can hold the foldable knife 1 with one hand, and press the push button 12 with a thumb of the same hand, in order to release the blade 11 from the engagement of the push button 12. Then, the torsion spring 14 will bias the blade 11 with the torque to rotate the blade 11 out of the handle 10, so that the blade 11 springs out of the handle 10. Therefore, the user can operate and use the foldable knife 1. As a result, the foldable knife 1 is not only easy to operate, but also effectively solves the foregoing problems of the traditional foldable knife.

Although the foldable knife 1 is easy to operate, the push button 12 thereof is protruding out of the handle 10 and may be accidentally pressed. For example, if the user accidentally drops the foldable knife 1 to the ground, the push button 12 may be accidentally pressed by an impact force of the ground. As a result, the blade 11 will be released from the engagement of the push button 12, and spring out of the handle 10. The foldable knife 1 when dropped may endanger someone close thereto. Furthermore, the blade 11 may be damaged by the impact force of the ground, thereby shortening the service life of the foldable knife 1. Moreover, if the user puts the foldable knife 1 into a pocket, the push button 12 may be accidentally pressed and thereby release the blade 11 from the engagement of the push button 12. As a result, the blade 11 will spring out of the handle 10 and cut the user's clothes or even cut or pierce the user.

Hence, it is important to design and manufacture a foldable knife which is not only more convenient but also safer to operate.

It is therefore tried by the inventor to develop a foldable knife to solve the problems associated with the traditional foldable knives, as described above.

### SUMMARY OF THE INVENTION

A primary object of the present invention is to provide a foldable knife, which comprises a handle, a blade, a resilient bar, and a switch element. The handle has a first side formed with a recessed receiving space and a second side formed with two corresponding grooves therein. The blade has an end pivotally connected to a pivotal portion at a first end of the handle, so that the blade can be rotated out of the handle in relation to the pivotal portion. The resilient bar has a first end fixedly mounted to an inner portion of the handle adjacent to a second end thereof, and a second end extended to another inner portion of the handle adjacent to the pivotal position where the handle and the blade are pivotally connected. When the blade is completely received in the handle, the resilient bar biases the blade with a torque to rotate the blade into the handle, so that the blade is stably kept in the handle. When the blade is rotated outward from handle up to a predetermined angle, the resilient bar biases the blade with a torque to rotate the blade out of the handle, so that the blade springs automatically out of the handle. The switch element has a first end extended out of the handle for being switched by a user. The switch element further has two side surfaces, each of which is formed with a protrusion. The two protrusions correspond to the two grooves, respectively, so that the switch element can be slid along the grooves. When the user switches the first end of the switch element, a second end of the switch element biases the blade and thereby rotates the blade up to the predetermined angle. Then, the resilient bar biases the blade with the torque to rotate the blade out of the handle, so that the blade springs out of the handle. Thus, the user can hold the foldable knife with one hand, and switch the switch element with the same hand to make the blade spring automatically out of the handle. As a result, the present invention can substantially enhance the operating convenience of the foldable knife, and prevent the blade from accidentally cutting the user's hand when drawn by the user, as is the case with the traditional foldable knife. Furthermore, according to the foldable knife of the present invention, the blade will not easily spring out of the handle due to an impact force, thereby effectively preventing the blade from being damaged by the impact force, and protecting the user from being cut or pierced by the blade that has sprung out.

A secondary object of the present invention is to provide the aforementioned foldable knife which further comprises a spring, wherein the spring has a first end connected to an inner portion of the handle and a second end biasing against the switch element. When the user switches the first end of the switch element to actuate the second end thereof to apply a force to the blade, the blade will spring out of the handle due to a torque of the resilient bar. Then the switch element will return to an original un-switched position due to a resilience of the spring. As a result, the user can switch the switch element with only one hand to make the blade spring out of the handle, and the switch element can automatically return to the original un-switched position due to a resilience of the spring. Thus, the user does not need to manually switch the switch element to the original un-switched position. This substantially increases the operating convenience of the foldable knife and saves the time for operating the foldable knife.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view of a traditional foldable knife;

FIG. 2 is a cross-sectional view of a foldable knife according to a first preferred embodiment of the present invention;

FIG. 3 is an exploded perspective view of the foldable knife according to the first preferred embodiment of the present invention;

FIG. 4 is a partial, assembled perspective view of the foldable knife according to the first preferred embodiment of the present invention;

FIG. 5 is a cross-sectional view of a foldable knife according to a second preferred embodiment of the present invention;

FIG. 6 is an exploded perspective view of a foldable knife according to a third preferred embodiment of the present invention;

FIG. 7 is an exploded perspective view of a foldable knife according to a fourth preferred embodiment of the present invention; and

FIG. 8 is a cross-sectional view of a foldable knife according to a fifth preferred embodiment of the present invention.

### DETAILED DESCRIPTION OF THE PREFERRED EMBODIMENTS

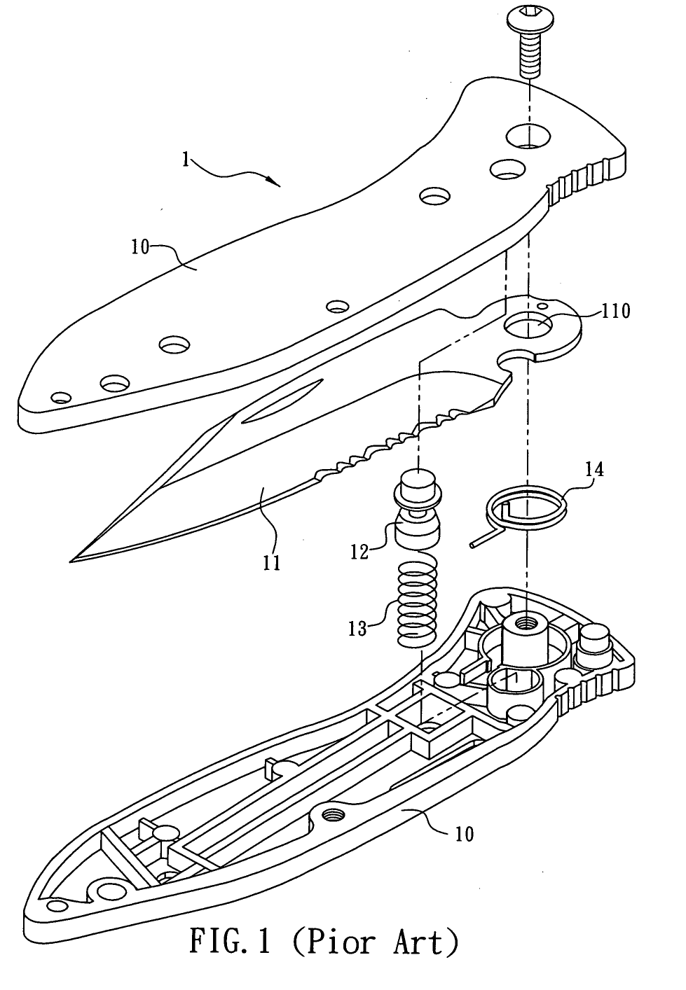

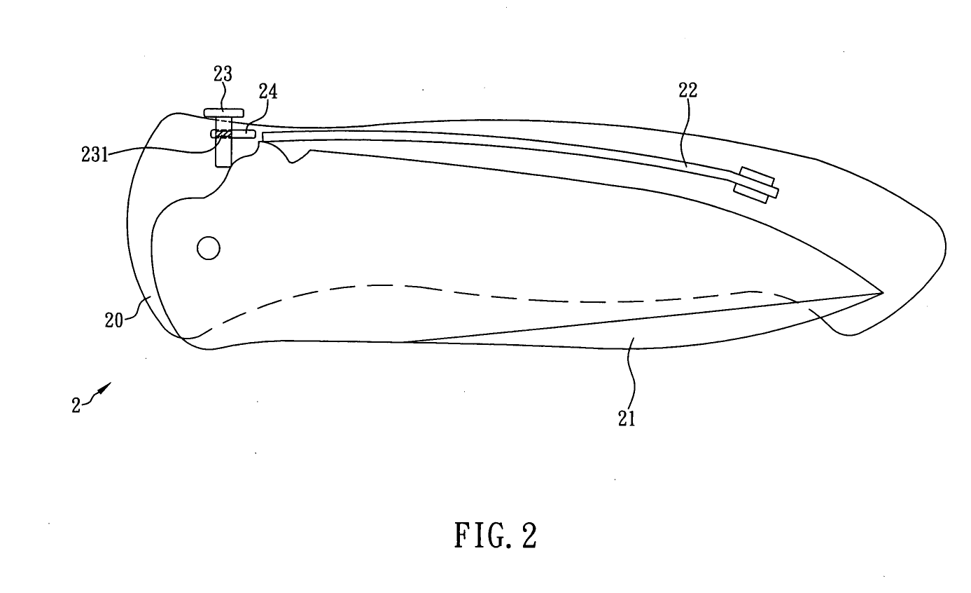

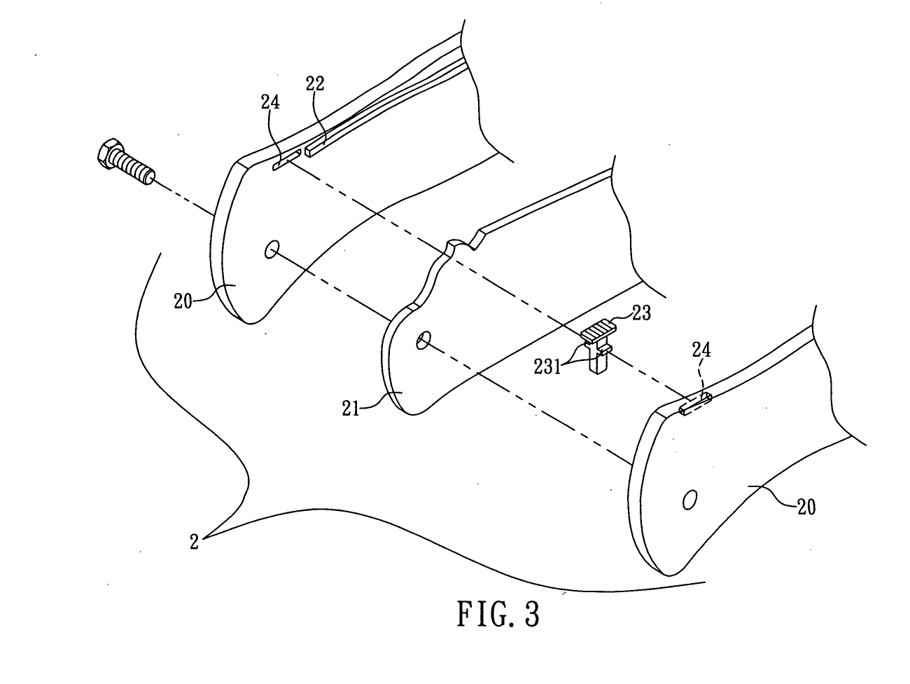

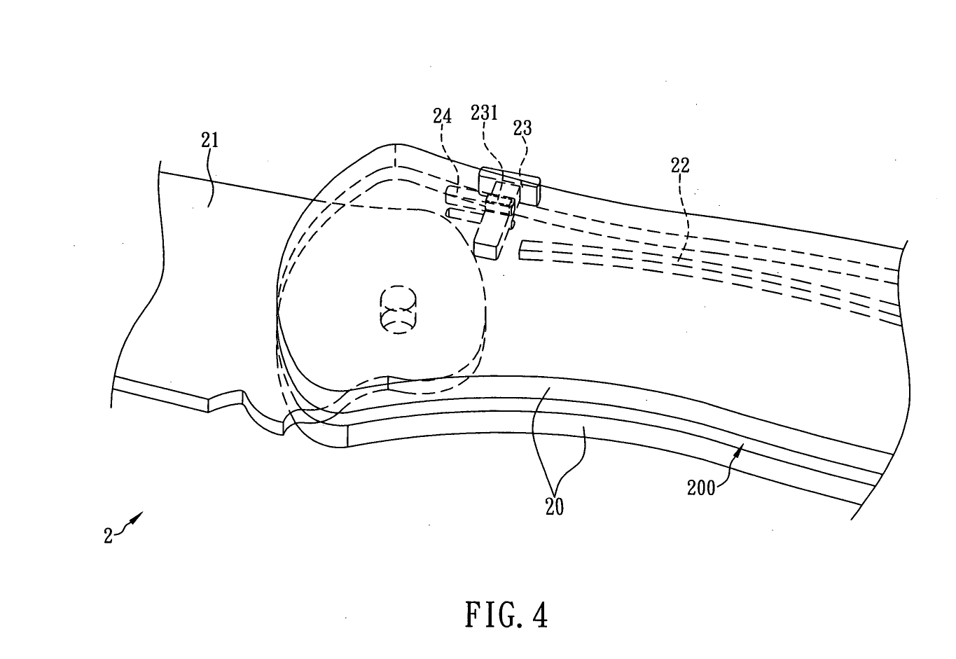

Referring now to FIGS. 2, 3, and 4, wherein a foldable knife according to a first preferred embodiment of the present invention is illustrated. As shown, the foldable knife designated by numeral 2 comprises a handle 20, a blade 21, a resilient bar 22, and a switch element 23. The handle 20 has a first side formed with a recessed receiving space 200 and a second side formed with two corresponding grooves 24 therein. The blade 21 has a n end pivotally connected to a pivotal portion at a first end of the handle 20, so that the blade 21 can be rotated out of the receiving space 200 of the handle 20 in relation to the pivotal position. The resilient bar 22 has a first end fixedly mounted to an inner portion of the receiving space 200 adjacent to a second end of the handle 20, and a second end extended to another inner portion of the receiving space 200 adjacent to the pivotal position where the handle 20 and the blade 21 are pivotally connected. When the blade 21 is rotated outward from the handle 20 up to a predetermined angle, the resilient bar 22 biases the blade 21 with a torque to rotate the blade 21 out of the handle 20, so that the blade 21 can automatically spring out of the handle 20. When the blade 21 is completely received in the receiving space 200 of the handle 20, the resilient bar 22 biases the blade 21 with a torque to rotate the blade 21 into the handle 20, so that the blade 21 can be stably kept in the handle 20. The switch element 23 has a first end extended out of the handle 20 for being switched by a user. The switch element 23 further has two side surfaces, each of which is formed with a protrusion 231. The two protrusions 231 correspond to the two grooves 24, respectively, so that the switch element 23 can be slid along the grooves 24. Thus, when the user presses the first end of the switch element 23 with a thumb, and switch the switch element 23 by sliding the switch element 23 along the grooves 24, a second end of the switch element 23 will bias the blade 21 and thereby rotate the blade 21 up to the predetermined angle. Then, the resilient bar 22 biases the blade 21 with the torque to rotate the blade 21 out of the handle 20, so that the blade 21 spring automatically out of the handle 20. In the first preferred embodiment of the present invention, the user can hold the foldable knife 2 with only one hand, and switch the switch element 23 with the same hand to make the blade 21 spring automatically out of the handle 20. As a result, the present invention can substantially enhance the operating convenience of the foldable knife 2, and protect the user from being accidentally cut when the user manually draws the blade 21, as in the case with the traditional foldable knife 1 shown in FIG. 1. Furthermore, according to the foldable knife 2 of the present invention, even when the user accidentally drops the foldable knife 2 to the ground, the switch element 23 will not be easily switched due to an impact force. In other words, the blade 21 will not be easily pushed to the predetermined angle by the switch element 23 and spring automatically out of the handle 20. This not only effectively prevents the blade 21 from being damaged by the impact force, but also protects the user from being cut or pierced by the blade 21 that would otherwise spring out automatically.

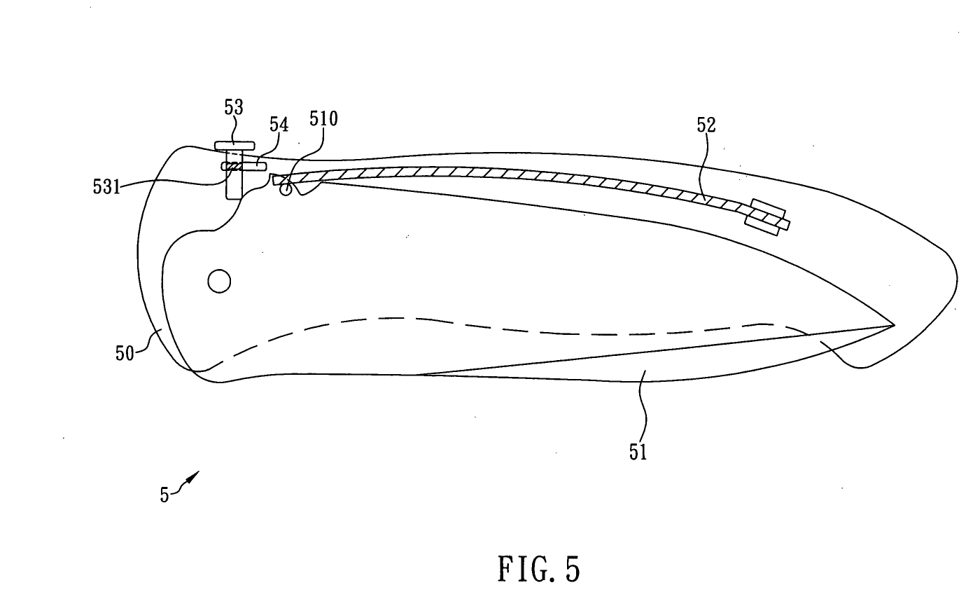

FIG. 5 illustrates a foldable knife according to a second preferred embodiment of the present invention. As shown, the foldable knife designated by numeral 5 comprises a handle 50, a blade 51, a resilient bar 52, and a switch element 53. The handle 50 has a first side formed with a recessed receiving space (unlabeled) and a second side formed with two corresponding grooves 54 therein. The blade 51 has an end pivotally connected to a pivotal portion at a first end of the handle 50, so that the blade 51 can be rotated into or out of the handle 50 in relation to the pivotal portion. The blade 51 is formed on a side surface thereof with a protruded engaging portion 510 adjacent to the pivotal position. The resilient bar 52 has a first end fixedly mounted to an inner portion of the handle 50 adjacent to a second end thereof, and a second end engaged with the engaging portion 510. When the blade 51 is completely received in the handle 50, the resilient bar 52 can bias the engaging portion 510 of the blade 51 with a torque to rotate the blade 51 into the handle 50, so that the blade 51 can be stably kept in the handle 50. When the blade 51 is rotated outward from the handle 50 up to a predetermined angle, the resilient bar 52 can bias the engaging portion 510 of the blade 51 to rotate the blade 51 out of the handle 50, so that the blade 51 can automatically spring out of the handle 50. The switch element 53 has a first end extended out of the handle 50 for being switched by a user.

The switch element 53 further has two side surfaces, each of which is formed with a protrusion 531. The two protrusions 531 correspond to the two grooves 54, respectively, so that the switch element 53 can be slid along the grooves 54. Thus, when the switch element 53 is switched, the switch element 53 can bias the blade 51 and thereby rotate the blade 51 up to the predetermined angle. Then, the resilient bar 52 will bias the engaging portion 510 of the blade 51, so that the blade 51 springs automatically out of the handle 50 due to a resilience of the resilient bar 52.

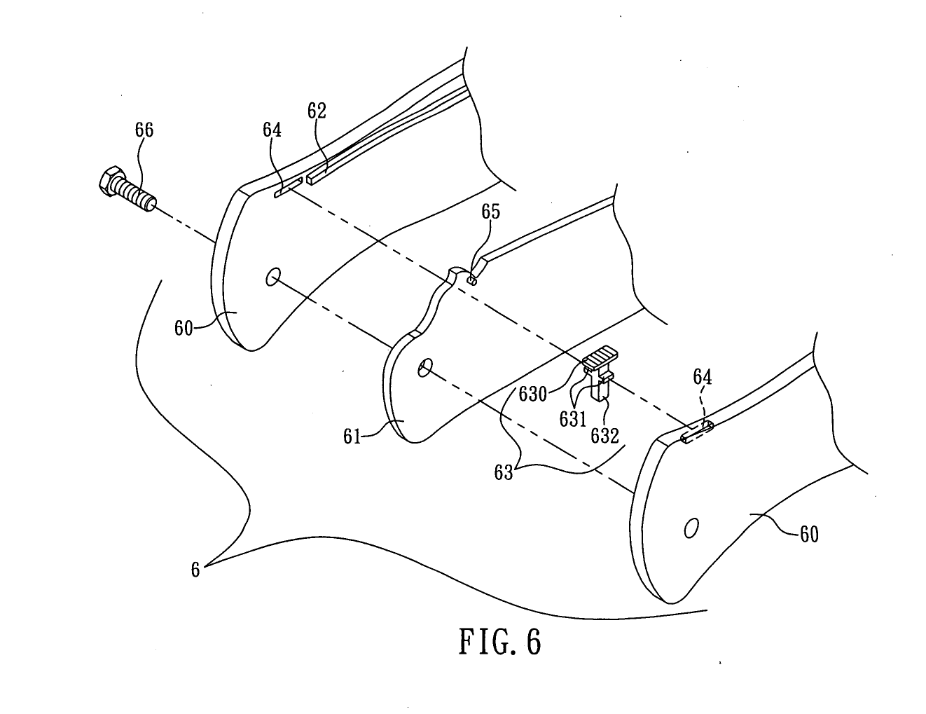

Referring now to FIG. 6, wherein a foldable knife according to a third preferred embodiment of the present invention is illustrated. As shown, the foldable knife designated by numeral 6 comprises a handle 60, a blade 61, a resilient bar 62, and a switch element 63. The handle 60 has a first side formed with a recessed receiving space (unlabeled) and a second side formed with two corresponding grooves 64 therein. The blade 61 has an end pivotally connected to a pivotal portion at a first end of the handle 60 by a screw element 66, so that the blade 61 can be rotated in relation to the pivotal portion. The blade 61 further has at least one side surface formed with a protruded biased portion 65 adjacent to the pivotal portion. The resilient bar 62 has a first end fixedly mounted to an inner portion of the handle 60 adjacent to a second end thereof, and a second end extended to another inner portion of the handle 60 adjacent to the pivotal portion where the handle 60 and the blade 61 are pivotally connected. When the blade 61 is rotated outward from the handle 60 up to a predetermined angle, the resilient bar 62 can bias the blade 61 with a torque to rotate the blade 61 out of the handle 60, so that the blade 61 can spring speedily and automatically out of the handle 60. The switch element 63 has a first end extended out of the handle 60 and formed with a slip-resistant portion 630, wherein the slip-resistant portion 630 is to be pressed by the user so that the switch element 63 can be conveniently pushed. The switch element 63 further has two side surfaces, each of which is formed with a protrusion 631. The two protrusions 631 correspond to the two grooves 64, respectively, so that the switch element 63 can be slid along the grooves 64. The switch element 63 further has a second end formed with a push portion 632. When the user switches the slip-resistant portion 630 of the switch element 63, the push portion 632 of the switch element 63 biases the biased portion 65 of the blade 61 and thereby rotates the blade 61 up to the predetermined angle. Thus, the resilient bar 62 can bias the blade 61 with a torque to rotate the blade 61 out of the handle 60, so that the blade 61 springs automatically out of the handle 60. As a result, the user can speedily use the foldable knife 6 without having to manually draw the blade 61 out of the handle 60, thereby effectively saving the time for operating the foldable knife 6.

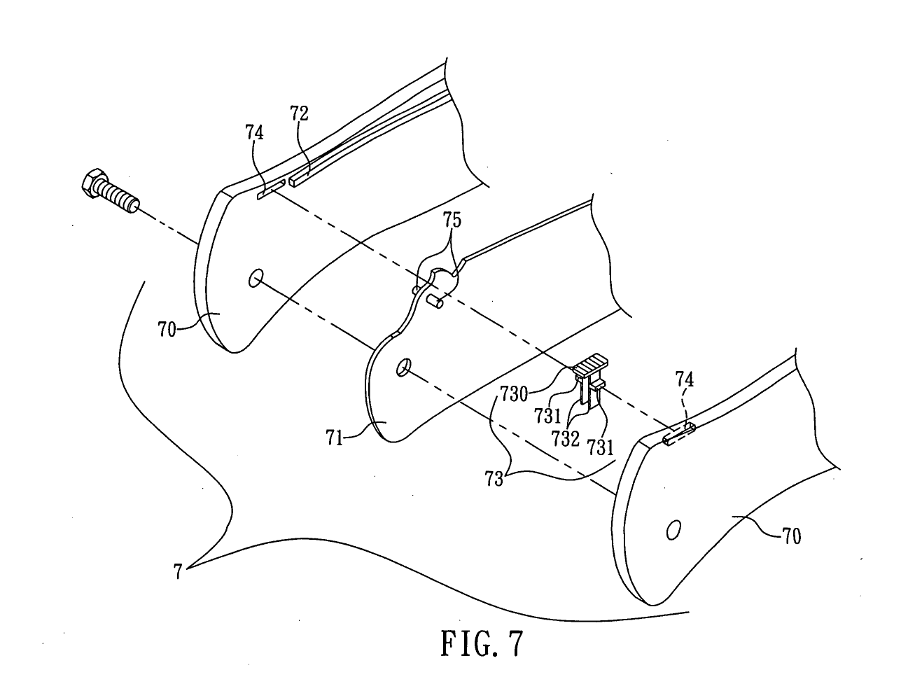

FIG. 7 illustrates a foldable knife according to a fourth preferred embodiment of the present invention is illustrated. As shown, the foldable knife designated by numeral 7 comprises a handle 70, a blade 71, a resilient bar 72, and a switch element 73. The handle 70 has a first side formed with a recessed receiving space (unlabeled) and a second side formed with two corresponding grooves 74 therein. The blade 71 has an end pivotally connected to a pivotal portion at a first end of the handle 70. The blade 71 further has two side surfaces, each of which is formed with a protruded biased portion 75. The resilient bar 72 has a first end fixedly mounted to an inner portion of the handle 70 adjacent to a second end thereof, and a second end extended to another inner portion of the handle 70 adjacent to the pivotal portion where the handle 70 and the blade 71 are pivotally connected. When the blade 71 is rotated outward from the handle 70 up to a predetermined angle, the resilient bar 72 biases the blade 71 with a torque to rotate the blade 71 out of the handle 70 and thereby pushes the blade 71, so that the blade 71 springs automatically out of the handle 70. The switch element 73 has a first end extended out of the handle 70 and formed with a slip-resistant portion 730. The switch element 73 further has a second end including two push portions 732. Each of the two push portions 732 has a side surface which is adjacent to the handle 70 and formed with a protrusion 731. The two protrusions 731 correspond to the two grooves 74, respectively, so that the switch element 73 can be slid along the grooves 74. Thus, the foldable knife 7 according to the fourth preferred embodiment of the present invention is formed. When the user switches the slip-resistant portion 730 of the switch element 73, the two push portions 732 of the switch element 73 bias the two biased portions 75 of the blade 71 and thereby push the blade 71, so that the blade 71 is rotated up to the predetermined angle. Then, the resilient bar 72 can bias the blade 71, so that the blade 71 springs automatically out of the handle 70. As described above, the user can use only one hand to hold the foldable knife 7, press the slip-resistant portion 730 and then switch the switch element 73 to make the blade 71 spring automatically out of the handle 70. This substantially enhances the operating convenience of the foldable knife 7.

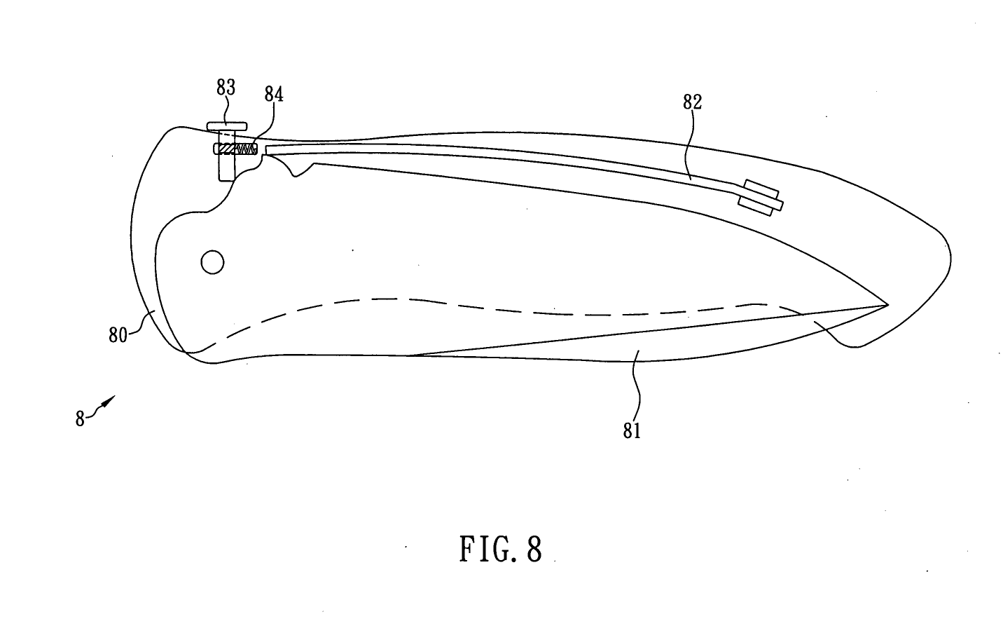

FIG. 8 illustrates a foldable knife according to a fifth preferred embodiment of the present invention is illustrated. As shown, the foldable knife designated by numeral 8 comprises a handle 80, a blade 81, a resilient bar 82, a switch element 83, and a spring 84, wherein the spring 84 has a first end connected to an inner portion of the handle 80 and a second end biasing against the switch element 83. When the user switches a first end of the switch element 83, a second end of the switch element 83 forces the blade 81 to rotate up to a predetermined angle. Meanwhile, the switch element 83 compresses the spring 84 to generate an elastic deformation of the spring 84. Then, the resilient bar 82 biases the blade 81 with a torque to rotate the blade 81 out of the handle 80, so that the blade 81 springs out of the handle 80. Furthermore, the switch element 83 can return to an original un-switched position due to a resilience of the spring 84. As a result, after the user switches the switch element 83 with one hand to make the blade 81 spring automatically out of the handle 80, the switch element 83 automatically returns to the original un-switched position due to the resilience of the spring 84. Thus, the user does not need to manually switch the switch element 83 to the original un-switched position. This substantially saves the time for operating the foldable knife 8. Moreover, if the user puts the foldable knife 8 into a pocket and accidentally touches the switch element 83, the switch element 83 is prevented from being switched because the spring 84 is biasing against the switch element 83. As a result, the blade 81 will not easily spring out of the handle 80. This not only secures the safety of the user effectively, but also overcomes the problems associated with the traditional foldable knife 1.

The present invention has been described with preferred embodiments thereof and it is understood that many changes and modifications to the described embodiment can be carried out without departing from the scope and the spirit of the invention that is intended to be limited only by the appended claims.

What is claimed is:

1. A foldable knife, comprising:
a handle having a first side formed with a recessed receiving space and a second side formed with two corresponding grooves therein;
a blade having an end pivotally connected to a pivotal portion at a first end of the handle, so that the blade can be rotated into the receiving space of the handle in relation to the pivotal portion, or rotated out of the handle in relation to the pivotal portion;
a resilient bar having a first end fixedly mounted to an inner portion of the receiving space adjacent to a second end of the handle, and a second end extended to another inner portion of the receiving space adjacent to the pivotal portion where the handle and the blade are pivotally connected; wherein when the blade is completely received in the receiving space, the resilient bar biases the blade with a torque to rotate the blade into the receiving space, so that the blade can be stably kept in the receiving space; and when the blade is rotated outward from the handle up to a predetermined angle, the resilient bar biases the blade with a torque to rotate the blade out of the handle, so that the blade can spring automatically out of the handle; and
a switch element having a first end extended out of the handle for being switched by a user, and further having two side surfaces, each of which is formed with a protrusion, wherein the two protrusions correspond to the two grooves, respectively, so that the switch element can be slid along the grooves; and when the switch element is switched, a second end of the switch element can bias the blade and thereby rotate the blade up to the predetermined angle, so that the resilient bar can bias the blade with the torque to rotate the blade out of the handle and make the blade spring out of the handle.

2. The foldable knife of claim 1, further comprising a spring, wherein the spring has a first end connected to an inner portion of the handle and a second end biasing against the switch element; and when the switch element is switched, the switch element can return to an original un-switched position due to a resilience of the spring.

3. The foldable knife of claim 2, wherein the blade has at least one side surface formed with a protruded biased portion; and when the first end of the switch element is switched, the second end of the switch element can bias the biased portion of the blade and thereby rotate the blade up to the predetermined angle.

4. The foldable knife of claim 3, wherein the first end of the switch element extended out of the handle is formed with a slip-resistant portion for being pressed by the user.
